(19) United States
(12) Patent Application Publication
(10) Pub. No.: US 2008/0249826 A1
(43) Pub. Date: Oct. 9, 2008

(54) System and method for integrated asset protection

(76) Inventors: Jeff Tolnar, Columbus, OH (US); Heidi Caroline, Meadville, PA (US); Larry Hymer, Columbus, OH (US); Michael Bauer, San Francisco, CA (US)

Correspondence Address: BUCHANAN, INGERSOLL & ROONEY PC, POST OFFICE BOX 1404, ALEXANDRIA, VA, 22313-1404, US

(21) Appl. No.: 12/078,029

(22) Filed: Mar. 26, 2008

Related U.S. Application Data
(60) Provisional application No. 60/907,194, filed on Mar. 26, 2007.

(51) Int. Cl. G06Q 10/00

(52) U.S. Cl. 705/8

(57) ABSTRACT

Provided is a system and method for monitoring in real time the status of assets of a resource distribution system and enacting a change in the resource utilization in order to protect the assets before they reach a failed state. The system may include sensors, a central control system, and a demand dispatch system. The system and method may protect individual or holistic resource distribution system assets by monitoring the operating conditions of those assets and governing the aggregated resource utilization within the governed service area.

### RELATED APPLICATIONS

This disclosure claims the benefit of prior Provisional Application No. 60/907,194 filed on Mar. 26, 2007, which hereby incorporated by reference in its entirety.

The utility application entitled “SYSTEM AND METHOD FOR DEMAND DISPATCH AND LOAD MANAGEMENT” filed on Mar. 24, 2008 is assigned to a common assignee as the present disclosure, and is hereby incorporated by reference in its entirety.

### FIELD OF THE INVENTION

This invention relates generally to a system and method of protecting individual or holistic utility resource distribution system assets (e.g., electricity distribution assets) by monitoring the real time condition of those assets and governing the aggregated resource utilization within the governed service area.

### BACKGROUND OF THE INVENTION

Management of generation and distribution of a resource is highly desirable. This is especially true in the distribution of utility resources, for example, electricity, gas, and water. In today's utility assets may include circuits and components (e.g., reclosers, fuses, and transformers).

The industry to date has focused predominantly on the supply side of energy delivery, and thus, has built assets designed to more efficiently and effectively deliver the resource (e.g., electricity, gas, and water) to end users. These assets were put into place prior to the information age and the dramatic increase in demand. Consequently, these assets are continually at risk of being over utilized, which may cause failures to occur. In most instances, assets are not proactively monitored or controlled, and thus, merely the repair and/or replacement of a failed asset usually occurs.

When an asset fails, reliability is compromised and customer complaints usually follow, which may lead to the business sufferring. Costs are incurred in repairing the failed asset. Further, revenue may be curtailed due to the lack of service being provided.

One way to reduce asset failures is to schedule maintenance of various components based on generalized characteristics of the component (e.g., mean-time between failures). Under this approach, assets such as transformers are replaced wholesale after a predetermined period of use. This approach can reduce incidence of asset failures.

However, such wholesale replacement approach may have disadvantages. The approach will not prevent failure of assets whose actual mean-time between failures is shorter than the predetermined period of use. In addition, some of the assets may have actual time between failures that is significantly longer than the predetermined period of use. Replacing these assets may be unnecessary and costly.

### SUMMARY OF THE INVENTION

Exemplary embodiments of the invention enables a resource distribution system to monitor the status of its assets in real time and to enact a change in the resource utilization in order to protect the assets before they reach a failed state.

According to exemplary embodiments, a method of protecting assets of a resource distribution system may comprise monitoring operating conditions at asset locations within the resource distribution system to obtain condition data at the respective asset locations, comparing the condition data with respective threshold levels or problem/failure signatures, triggering an alarm when there is a threshold violation or problem/failure signature indicating the violation and at which asset location the violation occurred, and activating a demand dispatch system within the area of the respective asset location to curtail resource utilization in order to protect the respective assets before they reach a failed state.

The operating conditions are detected by sensors located at the respective asset locations. Each asset location comprises at least one asset. In an electricity distribution system, an asset may include at least one of a phase circuit, phase tap, transformer, switch, recloser, fuse, capacitor bank, distributed energy resource, and other utility devices.

The condition data may include at least one of current, harmonics, voltage sag, voltage, real power, reactive power, electromagnetic interference, gas pressure, water pressure, flow rate, bit error rate, signal strength, and other parameters indicative of the operational condition of a utility device.

The sensors may transmit the condition data to a central control system. The central control system stores the predefined threshold levels and problem/failure signatures.

The threshold violation occurs when a value of at least one of the condition data exceeds the respective threshold level or is within a given range of the respective threshold level.

The demand dispatch system monitors resource utilization and distribution across a distribution area and limits aggregated resource utilization, to a predefined utilization level, across individual components or the entire distribution area.

According to exemplary embodiments, an integrated asset protection system may comprise sensors detecting operating conditions at asset locations within a resource distribution system to obtain condition data at the respective asset locations, a central control system comparing the condition data with respective threshold levels or problem/failure signatures, and triggering an alarm when there is a threshold violation or problem/failure signature indicating the violation and at which asset location the violation occurred, and a demand dispatch system within the area of the respective asset location that is activated to curtail resource utilization in order to protect the respective assets before they reach a failed state.

### BRIEF DESCRIPTION OF THE DRAWINGS

Exemplary embodiments will be more clearly understood from the following detailed description taken in conjunction with the accompanying drawings. FIG. 1 represents non-limiting, exemplary embodiments as described herein.

FIG. 1 is a diagram illustrating a system for integrated asset protection according to exemplary embodiments.

### DETAILED DESCRIPTION OF THE INVENTION

For simplicity and illustrative purposes, the principles of the invention are described by referring mainly to exemplary embodiments thereof. The exemplary embodiments mainly refer to asset management regarding electricity distribution. However, one of ordinary skill in the art would readily recognize that the same principles are equally applicable to many types of integrated asset management situations including distribution of other utilities including gas and water. In addition, the invention is not limited to utility asset management. The scope of the invention encompasses many situations in which integrated assets are desired to be managed.

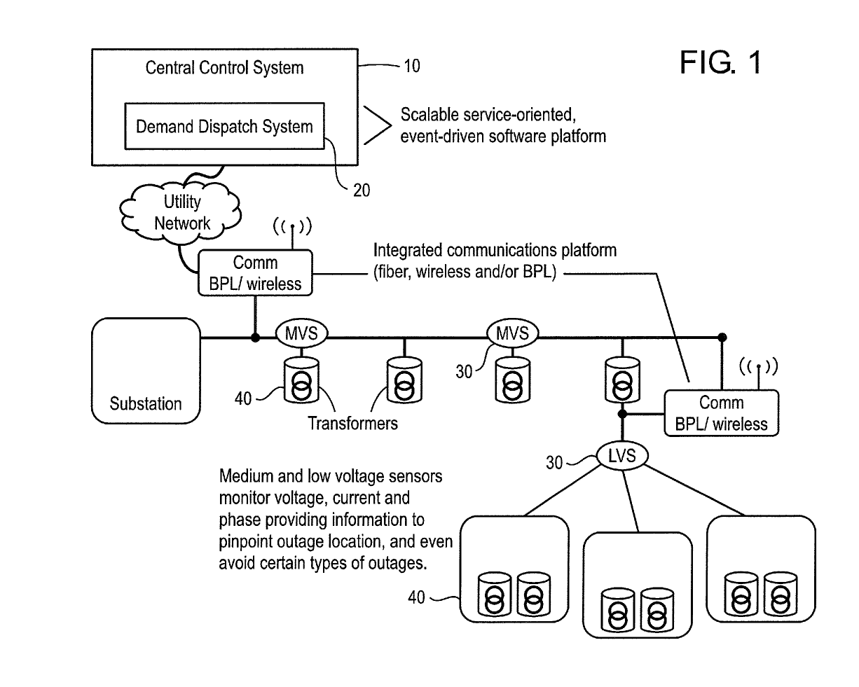

Referring to FIG. 1, an exemplary embodiment of the invention includes an integration of sensors 30, a central control system 10, and a demand dispatch system 20. The system may protect individual or holistic resource distribution system assets 40 by monitoring the real time condition of those assets and governing the aggregated resource utilization within the governed service area. The subcomponents of the system operate as described below.

Sensors 30 are placed at different points along the resource distribution grid based upon the protection needs of the assets 40. For example, the protection needs of full three phase circuits, one phase tap, and component locations (e.g., transformers, switches, reclosers, fuses, and distributed energy resources) may be considered. Thus, a sensor may detect the operating conditions of one or more assets 40.

The sensors 30 may include any one or a combination of commercially available sensors (e.g., optical current sensors, current transformers, broadband power line devices, and discrete voltage monitors). In addition, the sensors 30 may include devices specially developed for a particular use.

Data from the sensors 30 include, but are not limited to, real time current measurements, harmonics, voltage, reactive power, and electromagnetic interference readings. For gas or water distribution, data may include pressure (e.g., gas pressure or water pressure) and flow rate. For data distribution, data may include bit error rate and signal strength.

The sensors 30 may be connected to a communications network by either direct connection (e.g., Ethernet, FDDI, T1, T3, and, etc.) or by wireless connection (900 MHz, 2.4 GHz, WiFi, and etc.). The particular communications format used is not critical. The data from the sensors 30 is transmitted over the communications network back to a central control system 10 with constant attention to network availability and latency so that real time information gathering can be assured.

The sensors 30 capture the condition data of the assets 40 and report the data to the central control system 10. Load related stress thresholds (e.g., current, real power, reactive power, voltage sag, and etc.) or problem/failure signatures that compromise the integrity of system assets 40 can also be reported and stored at the central control system 10. A diagnosis of the operating conditions at the various asset points may be performed by comparing the condition data with the respective thresholds or problem/failure signatures. If the diagnosis indicates a threshold violation, a trend towards a threshold violation, or a likely problem or failure signature, an alarm is triggered within the system. Once an alarm is triggered, the type of violation is specified and isolated to the specific assets 40 where the sensor is located, and the demand dispatch system 20 within that asset footprint is activated to alleviate the problematic conditions.

The demand dispatch system 20 limits aggregated resource utilization across individual components or across an entire distribution area. A centralized software program can be utilized for the implementation. In particular, the system monitors and manages resource utilization available for curtailment within a customer premise, thus producing a greater control of the resource utilization across the entire service area. Once resource utilization is reduced, resource distribution system assets 40 are alleviated of operating stresses and failure conditions are prevented.

The demand dispatch system 20 will now be described in more detail below. However, the demand dispatch system is described in even greater detail in the previously cited, related application entitled “SYSTEM AND METHOD FOR DEMAND DISPATCH AND LOAD MANAGEMENT,” which is hereby incorporated by reference in its entirety.

The demand dispatch system 20 may include premise controllers, premise sensors, an enterprise management platform, a communications backbone shared by the premise controllers and premise sensors (e.g., Ethernet, BPL, dedicated point-to-point (T1 or frame relay), iDen Wireless, CDMA Wireless, GPRS Wireless, WiFi, and WiMax), and radio communication aggregators.

The enterprise management platform continuously monitors condition parameters of customer premises and system resource utilization throughout the deployed area on a premise by premise basis. For example, one or more devices (e.g., appliances) located at each customer premise may be monitored for temperature and/or utilization of the resource. The customer premise itself may be monitored for temperature as well.

The enterprise management platform, which can be implemented as a software program, uses configurable rules to manage individual resource utilization at the customer premise via a premise controller. The software uses algorithms to manage this information once it is returned to a central database to meet system prescribed resource utilization curtailment objectives and to protect the distribution assets 40.

The enterprise management platform may communicate, for example, through an IP based network with remotely located concentrator (e.g., aggregator) devices. Other forms of communication can be employed. The concentrator devices may connect to the premise controllers, for example, through 900 MHz radio or PLC/BPL links. As stated above, other forms of communication can be employed.

The premise controllers interact with the concentrators and send messages of condition changes at the customer premise. The messages can be sent as asynchronous messages. The condition changes monitored include internal ambient temperature, voltage, current of the device being controlled, and state of the device being controlled (e.g., on/off, power factor, and load profile).

An exemplary demand dispatch algorithm will now be described. The demand dispatch system 20 maintains a system wide and asset specific inventory of resource utilization by customer premises. This can be accomplished by having the system poll all of the premise controllers periodically (e.g., every 5 minutes) to gather information including ambient temperature, controlled device state (on/off, and controlled device voltage and current. Periodic self reporting by the premise controllers can also be employed.

The data, once obtained, is placed in a database on the enterprise management platform, listing the premise controller ID and the obtained data, for example, ambient temperature, device state (on/off), and the status of the voltage and current. The data can then be correlated with stored information in the database (e.g., physical address, customer preferences, and customer shed priority).

When the enterprise management platform calls for a curtailment in resource utilization, the system can start shedding resource usage based on predefined parameters of device priority, customer priority, and customer preference. The system calculates a cumulative total of the utilization by all devices that are running and compares a desired utilization level with the running cumulative total to obtain a desired reduction amount. A curtailment in utilization of the resource is initiated if the desired utilization level is lower than the running cumulative total.

The system can create groups of customer premises, based on priority, whose total resource utilization adds up to the desired reduction amount within the specific asset area. A group may have as few as one device as a member. When these groups have been set up, the system sends commands to the respective premise controller of the group to signal the controller to open a relay and interrupt the delivery of the resource to the controlled device. The premise controller sends a time stamped response to the system to notify that the delivery of the resource to the device has indeed been interrupted, including a current measurement reading verifying that the current is now zero. By comparing this change of state to the previous utilization of the resource by the device, the system can determine exactly how much of the resource utilization was curtailed and when.

The system may continuously monitor and compare the resource utilization that is required to be curtailed due to the asset condition, the current resource utilization, and the individual service level parameters. This process continues until the resource distribution area no longer needs the curtailment.

Priorities may be specified by a number of factors including the type of the device (e.g., HVAC, water heater, and pool pump), customer priority, and customer preferences. The controlled devices can represent anything at the customer premises that consumes the resource. The utility can set a priority of when certain devices are considered for demand curtailment and set a priority to each device. The algorithm may systematically group each device into the priority specified and shed from lowest priority to highest priority until the demand curtailment is satisfied.

As an alternative embodiment, a controller can be managed via a number of different communications scenarios including 900 MHz and BPL. The base load management technology can also be incorporated as a front end into other distributed and micro-generation products to extend their useful life. The asset protection system can be incorporated into a broader preventative maintenance algorithm including advanced correlation techniques and integrated with existing SCADA (supervisory control and data acquisition) or data mining applications.

It will be appreciated by those skilled in the art that the present invention can be embodied in other specific forms without departing from the spirit or essential characteristics thereof. The presently disclosed embodiments are therefore considered in all respects to be illustrative and not restricted.

What is claimed is:

1. A method of protecting assets of a resource distribution system, the method comprising:
monitoring operating conditions at asset locations within the resource distribution system to obtain condition data at the respective asset locations;
comparing the condition data with respective threshold levels or problem/failure signatures;
triggering an alarm when there is a threshold violation or problem/failure signature indicating the violation and at which asset location the violation occurred; and
activating a demand dispatch system within the area of the respective asset location to curtail resource utilization in order to protect the respective assets before they reach a failed state.

2. The method of claim 1, wherein sensors located at respective asset locations detect the operating conditions.

3. The method of claim 2, wherein the sensors include at least one of an optical current sensor, current transformer, broadband power line device, and discrete voltage monitor.

4. The method of claim 1, wherein each asset location comprises at least one asset, an asset including at least one of a phase circuit, phase tap, transformer, switch, recloser, fuse, capacitor bank, and distributed energy resource.

5. The method of claim 1, wherein the condition data includes at least one of current, harmonics, voltage sag, voltage, real power, reactive power, electromagnetic interference, gas pressure, water pressure, flow rate, bit error rate, and signal strength.

6. The method of claim 2, wherein the sensors transmit the condition data to a central control system over a communications network by either direct connection or wireless connection.

7. The method of claim 6, wherein the threshold levels and problem/failure signatures are predefined and are stored at the central control system.

8. The method of claim 1, wherein the threshold violation occurs when a value of at least one of the condition data exceeds the respective threshold level.

9. The method of claim 1, wherein the threshold violation occurs when a value of at least one of the condition data is within a given range of the respective threshold level.

10. The method of claim 1, wherein the demand dispatch system monitors resource utilization and distribution across a distribution area and limits aggregated resource utilization, to a predefined utilization level, across individual components or the entire distribution area.

11. An integrated asset protection system comprising:
sensors detecting operating conditions at asset locations within a resource distribution system to obtain condition data at the respective asset locations;
a central control system comparing the condition data with respective threshold levels or problem/failure signatures, and triggering an alarm when there is a threshold violation or problem/failure signature indicating the violation and at which asset location the violation occurred; and
a demand dispatch system within the area of the respective asset location that is activated to curtail resource utilization in order to protect the respective assets before they reach a failed state.

12. The system of claim 11, wherein the sensors are located at the respective asset locations.

13. The system of claim 11, wherein the sensors include at least one of an optical current sensor, current transformer, broadband power line device, and discrete voltage monitor.

14. The system of claim 11, wherein each asset location comprises at least one asset, an asset including at least one of a phase circuit, phase tap, transformer, switch, recloser, fuse, capacitor bank, and distributed energy resource.

15. The system of claim 11, wherein the condition data includes at least one of current, harmonics, voltage sag, voltage, real power, reactive power, electromagnetic interference, gas pressure, water pressure, flow rate, bit error rate, and signal strength.

16. The system of claim 11, wherein the sensors transmit the condition data to a central control system over a communications network by either direct connection or wireless connection.

17. The system of claim 16, wherein the threshold levels and problem/failure signatures are predefined and are stored at the central control system.

18. The system of claim 11, wherein the threshold violation occurs when a value of at least one of the condition data exceeds the respective threshold level.

19. The system of claim 11, wherein the threshold violation occurs when a value of at least one of the condition data is within a given range of the respective threshold level.

20. The system of claim 11, wherein the demand dispatch system monitors resource utilization and distribution across a distribution area and limits aggregated resource utilization, to a predefined utilization level, across individual components or the entire distribution area.
